(19) United States
(12) Patent Application Publication
(10) Pub. No.: US 2007/0121642 A1
(43) Pub. Date: May 31, 2007

(54) Method and system for supporting an emergency call

(76) Inventors: Robert D. Battin, Kildeer, IL (US); Gregory W. Cox, Schaumburg, IL (US); Zhi Fu, Lake Zurich, IL (US)

Correspondence Address: MOTOROLA, INC., 1303 EAST ALGONQUIN ROAD, IL01/3RD, SCHAUMBURG, IL, 60196, US

(21) Appl. No.: 11/265,483

(22) Filed: Nov. 2, 2005

(51) Int. Cl. H04L 12/56; H04L 12/28

(52) U.S. Cl. 370/395.2; 370/401

(57) ABSTRACT

A method and system for supporting an emergency call is disclosed. The method includes initiating (302) an emergency call through an Internet Protocol (IP) based system (108). The method further includes receiving (304) authorization for restricted access to the resources of the IP based system, only for the purpose of making the emergency call.

### FIELD OF THE INVENTION

The present invention relates generally to wireless networks, and more specifically to a method for supporting an emergency call in an Internet Protocol (IP) based system, such as a Wireless Local Area Network (WLAN) system.

### BACKGROUND

In an emergency, people need the ability to quickly contact an appropriate agency, such as the police, the fire department, or an ambulance. For such situations, a single telephone number, such as 911, is provided to connect emergency calls from a communication device to an emergency call center.

In cellular telephony systems, cellular operators are required to connect emergency calls to the emergency call center even if the communication device is not subscribed to the cellular telephony system. Therefore, users of un-subscribed communication devices have limited access to the resources of cellular telephony systems. However, in some cases such as the absence of cellular coverage or insufficient cellular capacity, emergency calls may need to be supported by a Wireless Local Area Network (WLAN) system. The WLAN system may connect the communication device to its resources by using Voice over Internet Protocol (VoIP). Therefore, users of un-subscribed communication devices need to be provided with limited access to the WLAN VoIP system for emergency calls.

Using WLAN systems for supporting emergency calls is problematic, since, conventionally, WLAN systems provide users with complete access to resources available within the WLAN system. In such a case, users of unsubscribed communication devices would be able to access resources they are not authorized to access, and which do not correspond to the emergency calls.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates communication between a communication device and an emergency call center via a communications network, in accordance with some embodiments of the present invention.

FIG. 2 is a flowchart illustrating a method for supporting an emergency call in a communication device, in accordance with some embodiments of the present invention.

FIG. 3 illustrates the communication network of FIG. 1 for supporting an emergency call, in accordance with various embodiments of the present invention.

FIG. 4 is a flowchart illustrating a method for supporting an emergency call, in accordance with various embodiments of the present invention.

FIG. 5 is a flow diagram illustrating messaging between elements of the communication network of FIG. 3, in accordance with various embodiments of the method for supporting an emergency call.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Before describing in detail embodiments that are in accordance with the present invention, it should be observed that the embodiments reside primarily in combinations of method steps and apparatus components related to supporting an emergency call. In this document, relational terms such as first and second, top and bottom, and the like may be used solely to distinguish one entity or action from another entity or action without necessarily requiring or implying any actual such relationship or order between such entities or actions. The terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the present invention described herein may be comprised of one or more conventional processors and unique stored program instructions that control the one or more processors to implement, in conjunction with certain non-processor circuits, some, most, or all of the functions of supporting an emergency call described herein. The non-processor circuits may include, but are not limited to, a radio receiver, a radio transmitter, signal drivers, clock circuits, power source circuits, and user input devices. As such, these functions may be interpreted as steps of a method for supporting an emergency call. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

A method and system for supporting an emergency call while restricting access to all other resources of an Internet Protocol (IP) based system is disclosed. The method includes initiating an emergency call through an IP based system. The method further includes receiving authorization for restricted access to resources of the IP based system for the purpose of making the emergency call only.

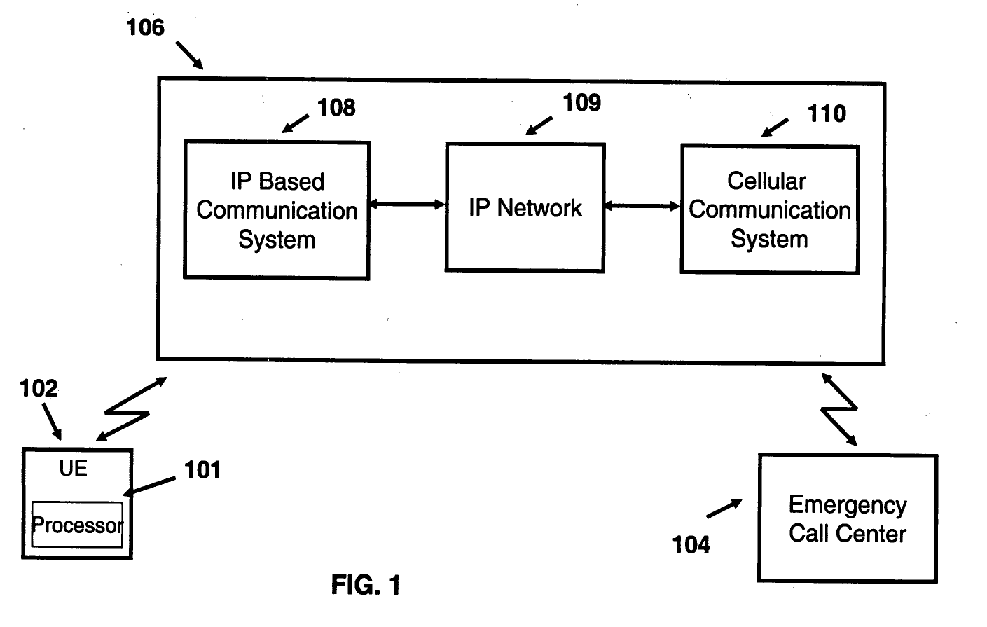

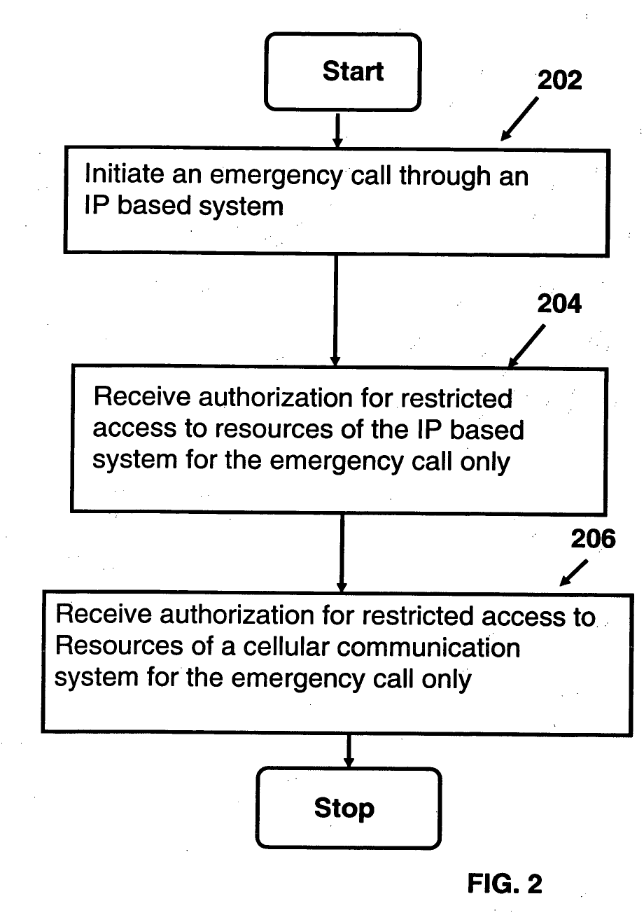

FIG. 1 illustrates communication between a communication device 102 and an emergency call center 104 via a communication network 106, in accordance with some embodiments of the present invention. Examples of the communication device 102 include, but are not limited to, a mobile phone, a third Generation Partnership Project (3GPP)-compliant mobile handset, a two-way pager, and a Personal Digital Assistant (PDA) wherein such example devices incorporate the ability to communicate through the IP based system 108. The communication device 102 includes a processor 101 and communicates with the emergency call center 104 through a communication network 106. The functions of the processor 101 will be described in conjunction with FIG. 2.

In an exemplary embodiment of the present invention, the communication network 106 includes an IP based system 108, an IP network 109 and a cellular communication system 110. Examples of the IP based system 108 may incorporate, but are not limited to, a Voice over Internet Protocol (VoIP), Internet Telephony, and WiFi. Examples of the IP Network 109 are a Digital Subscriber Line (DSL) network or a Hybrid Fiber Coaxial (HFC) Cable Network. Examples of the cellular communication system 110 include, but are not limited to, a Global System for Mobile Communications (GSM) network and a Code Division Multiple Access (CDMA) network. The communication device 102 is not subscribed to the IP based system 108. The communication network 106 supports an emergency call, from the communication device 102, even if the communication device 102 is not subscribed to the IP based system 108.

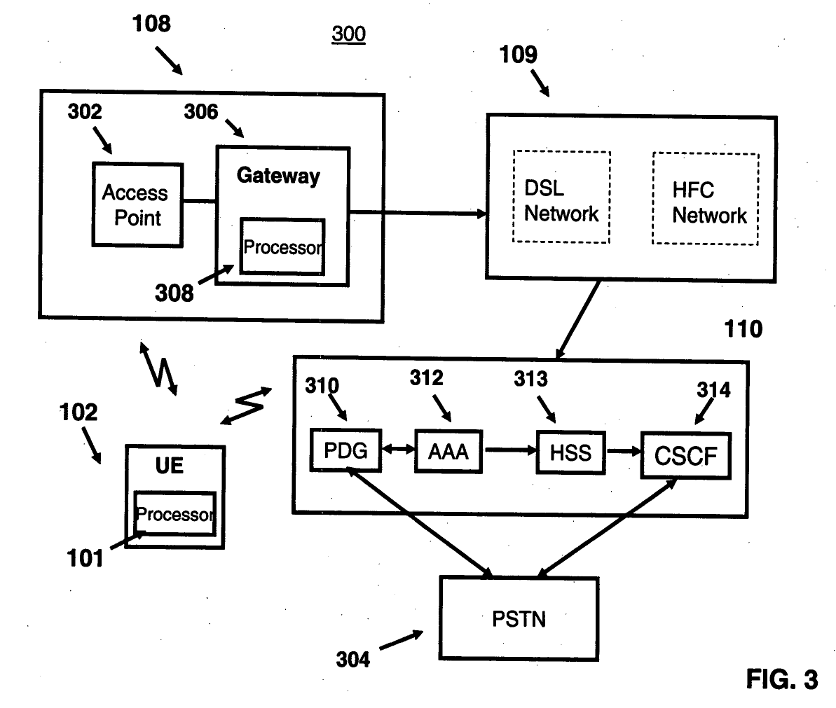

FIG. 2 is a flowchart illustrating a method for supporting an emergency call from the communication device 102, in accordance with some embodiments of the present invention. At step 202, a user of the communication device 102 makes an emergency call by, for example, dialing 911 to place a call to the emergency call center 104. The processor 101 initiates the emergency call through the IP based system 108. In accordance with an embodiment of the present invention, the processor 101 initiates the emergency call by sending an Extensible Authentication Protocol (EAP) message to a gateway (306 in FIG. 3). At step 204, the processor 101 receives authorization for restricted access to the resources of the IP based system 108, only for the purpose of making the emergency call. Therefore, the user of the communication device 102, which is not subscribed to the IP based system 108, is only authorized to access the resources of the IP based system 108, to make the emergency call. Access to IP based resources corresponding to a non-emergency call is denied. At step 206, the processor 101 receives authorization for restricted access to the resources of the cellular communication system 110, only for the purpose of completing the emergency call. The user of the communication device 102 is only authorized to access the resources of the cellular communication system 110, for the purpose of completing the emergency call. Access to Cellular Communication System resources corresponding to a non-emergency call is denied.

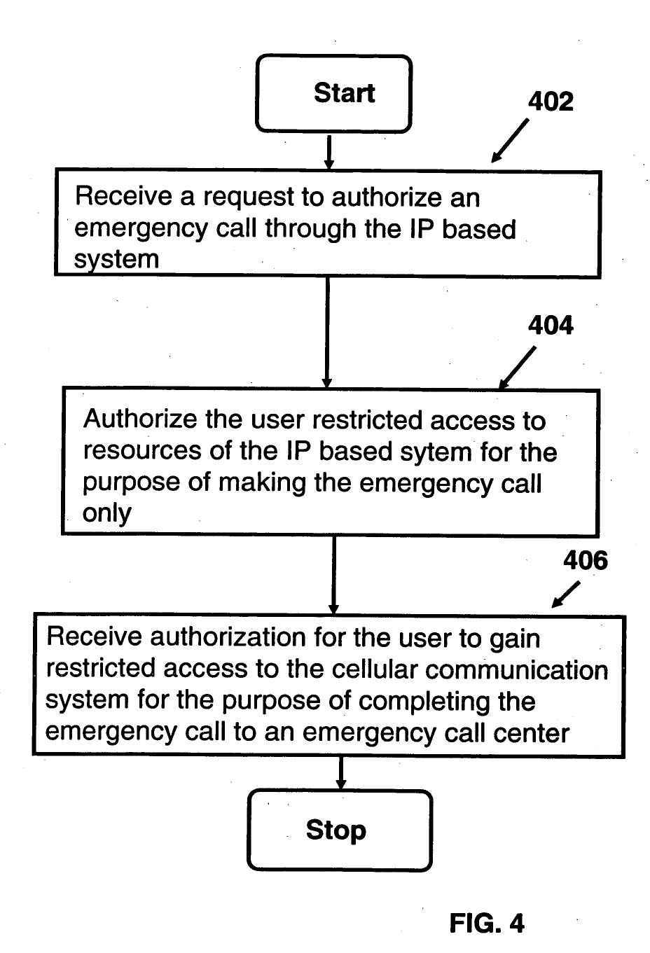

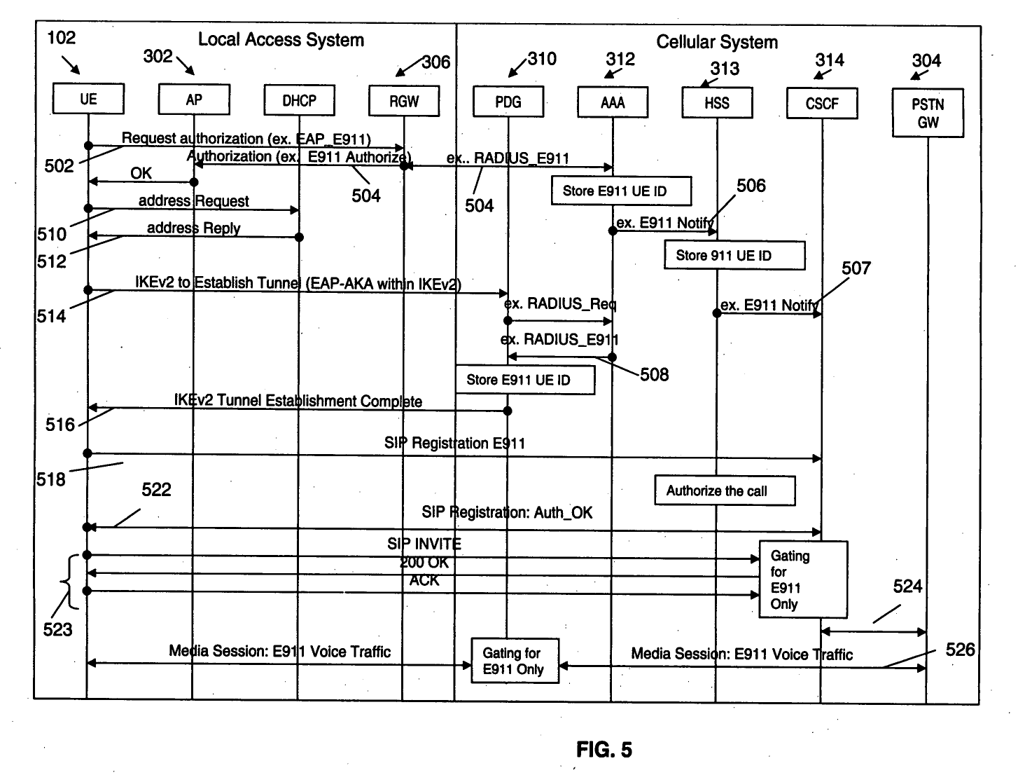

FIG. 3 illustrates a system 300 for supporting an emergency call, in accordance with some embodiments of the present invention. The system 300 includes the communication device 102, the IP based system 108, the IP Network 109, the cellular communication system 110, and a Public Switched Telephone Network (PSTN) 304. The IP based system 108 includes an Access Point 302 coupled to a gateway 306. The gateway 306 includes a processor 308. Details regarding the functions of these elements as they pertain to the present invention will be provided in conjunction with the descriptions of FIGS. 4 and 5.

In one embodiment, the IP Network 109 is a DSL network. A DSL network, as commonly known in the art, typically includes a Digital Subscriber Line Access Multiplier (DSLAM), such as a Broadband Digital Terminal/Universal Services Access Multiplier (BDT/USAM) commercially available from Motorola, Inc.; routers, and support servers such as Domain Name Server (DNS), Authentication Authorization and Accounting (AAA), and the like. The Customer Premise Equipment (CPE) portion of the DSL network (DSL router) can be either embedded in the gateway 306 or can be an external device in the home.

In another embodiment, the IP Network 109 is a HFC Cable network. A HFC Cable network, as commonly known in the art, typically includes a Cable Modem Termination System (CMTS), such as the BSR64000, commercially available from Motorola, Inc; routers, and support servers such as DNS, AAA, and the like. The cable modem is either embedded in the gateway 406 or would be an external device in the home. In both the DSL or HFC Cable Network case, the IP Network 109 provides access (routing) between the IP based system 108 and other IP entities including the (PDG) 310.

The cellular communication system 110 includes a Packet Data Gateway (PDG) 310, an AAA server 312, a Home Subscriber Server (HSS) 313 and a Call Session Control Function (CSCF) 314. Details regarding the functions of these elements as they pertain to the present invention will be provided in conjunction with the descriptions of FIGS. 4 and 5.

FIG. 4 is a flowchart illustrating a method for supporting the emergency call, in accordance with various embodiments of the present invention. The method will now be described in conjunction with FIG. 3. At step 402, the processor 308, present in the gateway 306, receives a request to authorize the emergency call. The user of the communication device 102 sends the request. The communication device 102 is not subscribed to the IP based system 108. In accordance with an embodiment of the present invention, the request is an Extensible Authentication Protocol (EAP) message, specifying that the emergency call requires authentication. In accordance with an embodiment of the present invention, the processor 308 determines that the communication device 102 is not subscribed to the IP based system 108 by interrogating the AAA server 312.

At step 404, the processor 308 authorizes the user of the communication device 102 restricted access to the resources of the IP based system 108, only for the purpose of making the emergency call. The user of the communication device 102, being a non-subscriber of the IP based system 108, is only allowed to access those resources of the IP based system 108 that correspond to the emergency call. The processor 308 authorizes the user of the communication device 102 by associating the communication device 102 with an access point 302. In accordance with an embodiment of the present invention, the access point is a WLAN access point.

At step 406, the processor 308 receives authorization for the user of the communication device 102 to gain restricted access to the resources of the cellular communication system 110. This authorization is for the purpose of completing the emergency call to the emergency call center 104. Access to the resources of the cellular communication system 110 for completing a non-emergency call, is denied. In one embodiment of the present invention, the AAA server 312 authorizes the user of the communication device 102 after receiving notification messages from the processor 308. The notification messages from the processor 308 notify the AAA server 312 about the request for the emergency call.

Turning now to FIG. 5, detailed messaging between the elements of FIG. 3 to implement an embodiment of the method of supporting an emergency call will be described. At step 502, the communication device 102 sends a message to the gateway 306 to inform the gateway 306 that an emergency call requires special authorization. In the present embodiment, the message is an EAP message. Upon receiving the notification, at step 504, the gateway 306 will authorize the emergency call by allowing the communication device 102 to associate with the IP based system's access point 302. At step 504, the gateway 306 also sends a message to the AAA server 312 in the cellular communication system 110 to notify it of the emergency call. In accordance with an embodiment of the present invention the emergency call is identified based on an International Mobile Station Identity (IMSI) associated with the communication device 102 that made a request for the emergency call. In accordance with one embodiment, the AAA server 312 is notified using a Remote Authentication Dial-in User Service (RADIUS) message. At step 506, the AAA server 312 subsequently sends a message to the HSS 313 to notify the HSS 313 of the emergency call. Subsequent to step 506 and prior to the SIP registration process beginning (step 518), the HSS 313 notifies the CSCF 314 about the emergency call and authorizes the call by sending a notification message to the CSCF 314 (step 507). This causes the CSCF 314 to reject all non-emergency calls. At step 508, the AAA server 312 notifies the PDG 310 about the emergency call. In accordance with an embodiment of the present invention, the AAA server uses a RADIUS message to notify the PDG 310 about the emergency call. Meanwhile, at steps 510 and 512, the communication device 102 obtains a local IP address through the DHCP (not shown). Further, at steps 514 and 516, the communication device 102 and the PDG 310 go through EAP-Authentication Key Agreement (EAP-AKA) within Internet Key Exchange version 2 (IKEv2) to establish an IPsec security association.

When the security association is completed at the PDG 310, registration of the communication device 102 commences at step 518. In accordance with an embodiment of the present invention, the registration is a Session Initiation Protocol (SIP) registration. The processor 308, present in the gateway 306, directs all traffic related to SIP signaling for the emergency call to the PDG 310 (step 522). At the same time, the processor 308 drops data packets that are addressed to locations other than the PDG 310. The CSCF 314 ensures that only an emergency call established to the Emergency Call Center 104 via the Public Switched Telephone Network (PSTN) 304 through a media gateway.

After SIP registration and SIP INVITE processing is completed (steps 522 and 523) and the CSCF 314 establishes the emergency call to the Emergency Call Center 104, the CSCF 314 redirects the voice bearer of the emergency call to the media gateway for the emergency call (step 524). At step 526, the PDG 310 routes the voice bearer packet data from the communication device 102 directly to the media gateway, without the voice bearer packet passing through the CSCF 314. The PDG 310 routes the voice signaling packet data from the communication device 102 directly to the CSCF 314 (step 526). The PDG 310 restricts all other packet data from the communication device 102 to prevent unauthorized usage of cellular communication system 110 resources. To accomplish this, the PDG 310 is informed of the Internet Protocol (IP) address of the media gateway and CSCF 314 for the emergency call by the HSS. In accordance with an embodiment of the present invention, the PDG 310 is pre-configured with the IP addresses of the media gateways and CSCF 314 used for the emergency calls placed by the unsubscribed communication devices.

In accordance with another embodiment of the present invention, the CSCF 314 separately sends the IP address of the media gateway for the emergency call, to the PDG 310. In accordance with yet another embodiment of the present invention, the emergency call remains routed through the CSCF 314 throughout the duration of the emergency call. In accordance with yet another embodiment of the present invention, if the optional encryption of SIP messages through the CSCF 314 is disabled, then the PDG 310 sniffs the emergency call SIP messages from the CSCF 314 to determine the IP address of the media gateway for the emergency call. The method and system described above allow a user of a communication device, which is not subscribed to the IP based system, to make an emergency call to an emergency call center, without compromising the security of the devices present in the IP based system. Unsubscribed communication devices are not allowed to access resources present in the IP based system, for the purpose of making non-emergency calls.

It will be appreciated the communication device 102 and the gateway 306 described herein may be comprised of one or more conventional processors and unique stored program instructions that control the one or more processors to implement, in conjunction with certain non-processor circuits, some, most, or all of the functions of the communication device and the gateway described herein. The non-processor circuits may include, but are not limited to, a radio receiver, a radio transmitter, signal drivers, clock circuits, power source circuits, and user input devices. As such, these functions may be interpreted as steps of a method to perform supporting an emergency call. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

We claim:

1. A method for supporting an emergency call comprising:
initiating an emergency call through an Internet Protocol (IP) based system; and
receiving authorization for restricted access to resources of the IP based system for the purpose of making the emergency call only.

2. The method of claim 1 further comprising receiving authorization for restricted access to resources of a cellular communication system for the purpose of completing the emergency call only.

3. The method of claim 1 wherein initiating an emergency call comprises sending an Extensible Authentication Protocol (EAP) message.

4. A method for supporting an emergency call comprising:
receiving a request to authorize an emergency call from a communication device placing an emergency call through an Internet Protocol (IP) based system, wherein the communication device is not a subscriber of the IP based system; and
authorizing the user restricted access to resources of the IP based system for the purpose of making the emergency call, wherein access to resources of the IP based system for non-emergency calls is denied.

5. The method of claim 4 further comprising:
receiving authorization for the user to gain restricted access to resources of a cellular communication system for the purpose of completing the emergency call to an emergency call center, wherein access to the resources of the cellular communication system for completing the non-emergency calls is denied.

6. The method of claim 4 wherein the request is an Extensible Authentication Protocol (EAP) message specifying that the emergency call requires authorization.

7. The method of claim 4 wherein the step of authorizing the user restricted access to resources of the IP based system comprises authorizing the user to associate with an access point of the system.

8. The method of claim 5 wherein before the step of receiving authorization for the user to gain restricted access to the resources of the cellular communication system, the method comprises informing the cellular communication system of the emergency call and an identification of the user placing the emergency call.

9. The method of claim 8 further comprising:
during a registration process,
identifying the emergency call and getting authorized by HSS; and
during an invitation process
directing traffic related to Session Initiation Protocol (SIP) signaling for the emergency call to a packet data gateway; and
dropping packets addressed to locations other than the packet data gateway.

10. The method of claim 9 further comprising:
the packet data gateway routing traffic related to SIP signaling for the emergency call to a call session control function, and dropping packets addressed to locations other than the call session control function; and
the packet data gateway routing the bearer traffic to a media gateway for a Public Switched Telephone Network (PSTN), and dropping packets addressed to locations other than the PSTN Gateway.

11. A communication device comprising a processor configured to initiate an emergency call through an Internet Protocol (IP) based system, and receive authorization for restricted access to resources of the IP based system for the purpose of making the emergency call only.

12. The communication device of claim 11 wherein the processor is further configured to receive authorization for restricted access to the resources of a cellular communication system for the purpose of completing the emergency call only.

13. The communication device of claim 11 wherein the processor is configured to initiate an emergency call by sending an Extensible Authentication Protocol (EAP) message through the IP based system.

14. A gateway comprising a processor configured to:
receive a request for an emergency call from a communication device placing an emergency call through an Internet Protocol (IP) based system, wherein the communication device is not a subscriber of the IP based system; and
authorize the user restricted access to resources of the IP based system for the purpose of making the emergency call, wherein access to resources of the IP based system for non-emergency calls is denied.

15. The gateway of claim 14 having a processor further configured to receive authorization for the user to gain restricted access to resources of a cellular communication system for the purpose of completing the emergency call to an emergency call center, wherein access to the resources of the cellular communication system for completing the non-emergency calls is denied.

16. The gateway of claim 14 wherein the processor is configured to authorize the user restricted access to the resources of the IP based system by authorizing the user to associate with an access point of the system.

17. The gateway of claim 15 wherein the processor is configured to inform the cellular communication system of the emergency call and an identification of the user placing the emergency call prior to receiving authorization for the user to gain restricted access to the resources of a cellular communication system.

18. The gateway of claim 17 wherein the processor is further configured to:
direct traffic related to Session Initiation Protocol (SIP) signaling for the emergency call to a packet data gateway; and
drop packets addressed to locations other than the packet data gateway.
